(19) United States
(12) Patent Application Publication
(10) Pub. No.: US 2016/0292903 A1
(43) Pub. Date: Oct. 6, 2016

(54) AVATAR AUDIO COMMUNICATION SYSTEMS AND TECHNIQUES

(71) Applicant: Intel Corporation, Santa Clara, CA (US)

(72) Inventors: Wenlong Li, Beijing,11 (CN); Xiaofeng Tong, Beijing, 11 (CN); Yangzhou Du, Beijing, 11 (CN); Thomas Sachson, Menlo Park (CA)

(21) Appl. No.: 14/773,933

(22) PCT Filed: Sep. 24, 2014
(86) PCT No.: PCT/CN2014/087313

§ 371 Date: Sep. 9, 2015

(51) Int. Cl. G06T 13/80; G06K 9/00; H04L 29/08; G06T 7/20; H04M 1/725; H04L 12/58

(52) U.S. Cl. CPC G06T 13/80; H04M 1/72544; H04M 1/72547; H04L 51/04; H04L 67/02; G06T 7/20; G06K 9/00268; H04M 2250/52; G10L 19/167

(57) ABSTRACT

Examples of systems and methods for transmitting avatar sequencing data in an audio file are generally described herein. A method can include receiving, at a second device from a first device, an audio file comprising: facial motion data, the facial motion data derived from a series of facial images captured at the first device, an avatar sequencing data structure from the first device, the avatar sequencing data structure comprising an avatar identifier and a duration, and an audio stream. The method can include presenting an animation of an avatar, at the second device, using the facial motion data and the audio stream.

### BACKGROUND

Messaging services including instant messaging services and email, among others, provide users with many different types of emoticons, or emotion icons, for expressing themselves more demonstratively. Emoticons can include animations where a series of images are used together to create a video or animation. These emoticons are selectable by users, and even often customizable by users. However, these approaches limit the creativity of users and limit the customizability of the animations to already created emoticons. Animations constrained by predefined emoticons are therefore not meeting user demands.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1F are schematic diagrams illustrating a system for displaying an avatar animation, according to an embodiment.

FIG. 2 is a flow chart illustrating a system for playing an animation with a selected avatar, according to an embodiment.

FIG. 3 is a flow chart illustrating a system for playing an animation using an audio file, according to an embodiment.

FIG. 4 is a flow chart illustrating a system for adjusting a frame rate of an image capture device, according to an embodiment.

FIG. 5 is a flow chart illustrating a system for sending an avatar in an audio file, according to an embodiment.

FIG. 6 is a block diagram of a device upon which one or more embodiments may be implemented.

FIG. 7 is a block diagram illustrating an animation device for displaying an avatar animation, according to an embodiment.

### DETAILED DESCRIPTION

As mentioned above, existing approaches generally constrain users to predefined emoticons and animations. Various systems and techniques are proposed here to present users with an option for creating a facial gesture driven animation.

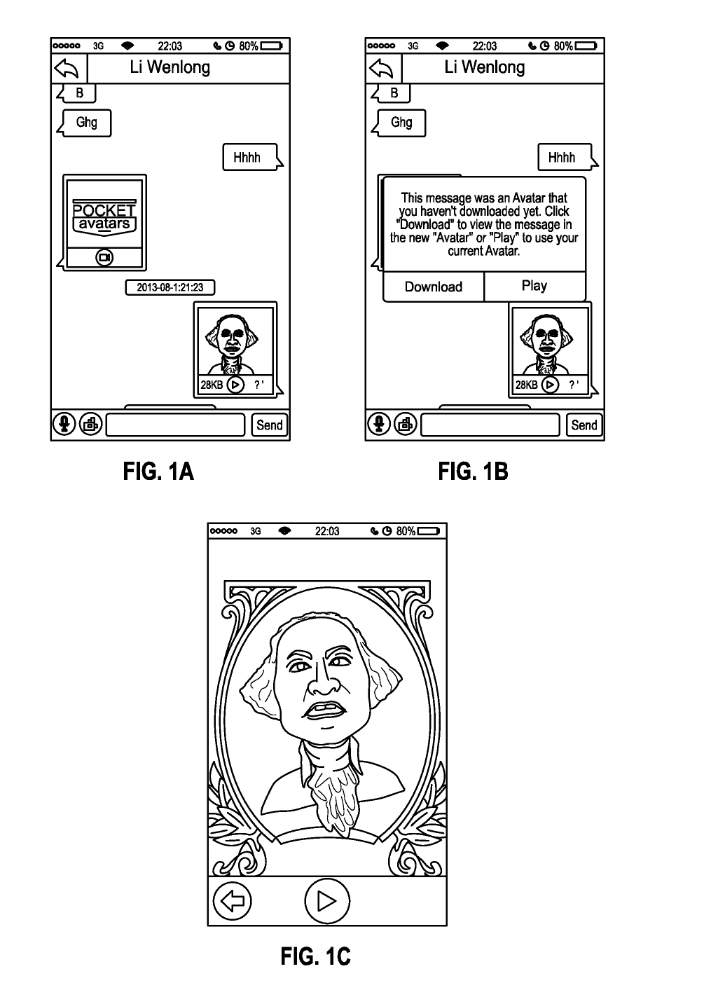

FIGS. 1A-1F are schematic diagrams illustrating a system for displaying an avatar animation, according to an embodiment. In an example, FIG. 1A is a schematic diagram illustrating a system for displaying an avatar animation, including a communication module receiving, at a second device from a first device, an audio file. The audio file may include facial motion data, an avatar sequencing data structure, or an audio stream. Facial motion data may be a set of facial coordinates, information about movements of a face, or the like. For example, facial motion data may be derived from a series of facial images captured at a first device. In an example, an avatar sequencing data structure may include an avatar identifier and a duration. For example, the avatar sequencing data structure may include an avatar identifier for an avatar selected by a user and a duration computed using an audio recording. The avatar sequencing data structure may include multiple avatar identifiers and multiple durations or an audio file may include multiple avatar sequencing data structures, each with a single avatar identifier and a single duration. An avatar identifier in an avatar sequencing data structure may correspond to a duration in the avatar sequencing data structure, or the avatar identifier and the duration may be unrelated. In an example, an audio stream can include music, speech, or any other type of audio recording.

FIG. 1B is a schematic diagram illustrating a system for displaying an avatar animation, including a presentation module that may present an animation of an avatar. The presentation module may use facial motion data and an audio stream to present the animation. In an example, when an audio file is received at a device, the device may determine if the audio file includes an avatar sequencing data structure, and if so, the device may identify an avatar identifier from the avatar sequencing data structure. The device may determine if the device has a copy of an avatar corresponding with the avatar identifier stored locally. If a copy of the avatar is stored locally, the device can display the animation using the avatar from local memory. If a copy of the avatar is not stored locally, the device may present an option to a user, such as the option presented in FIG. 1B. In an example, presenting an option may include presenting an option for a user to select a download option or a play option. In an example, if the user selects the download option, the device may download the avatar from a server or directly from another device. After downloading the avatar, the device may display an animation using the avatar. In an example, if the user selects the play option, the device may display an animation using an avatar from local memory of the device. In an example, the download option may include charging a fee to download an avatar, such as requiring payment, use of pre-purchased coins, or the like.

FIG. 1C is a schematic diagram illustrating a system for displaying an avatar animation, including displaying an animation using an avatar corresponding to an avatar identifier. In an example, displaying the animation may include using an avatar identifier received in an audio file, such as an avatar identifier in an avatar sequencing data structure in the audio file. For example, the avatar identifier may identify an avatar that the display device has stored locally. The display device may use the locally-stored avatar, identified by the avatar identifier, to display the animation. In another example, if the display device does not have the avatar identified by the avatar identifier stored locally, the display device may download the avatar from a server or other device and display the animation using the downloaded avatar.

FIG. 1D is a schematic diagram illustrating a system for displaying an avatar animation, including downloading an avatar. In an example, the avatar to download may be selected locally at the same device that downloads the avatar. The avatar may require payment, such as a specified amount of the 32 gold coins shown in FIG. 1D, which represent a current balance of an account accessed by the device. In an example, the avatar may be offered or sold from an online store and downloaded from a server. In another example, the avatar may be downloaded directly from another device and may require payment from either device or may be free.

FIG. 1E is a schematic diagram illustrating a system for displaying an avatar animation, including a communication module to send to an animation device, an audio file. The audio file may include facial motion data, an avatar sequencing data structure, or an audio stream, which are described above. The communication module may be in communication with an image capture device, which may capture a series of images of a face and send the images to a facial recognition module. The facial recognition module may compute facial motion data for each of the images in the series of images. After the audio file is sent to the animation device, the animation device may use the facial motion data and the audio stream to animate an avatar. The image capture device may include a camera. In an example, the facial recognition module may detect if a face is present in the series of images captured by the image capture device. When the facial recognition module detects that a face is present, an indication may be sent to the image capture device to operate at a normal frame rate. A frame rate may include a camera speed, a number of images to be stored, a number of images captured, a resolution, or the like. When the facial recognition module detects that a face is absent (i.e. not present), an indication may be sent to the image capture device to operate at a reduced frame rate. A reduced frame rate may be any frame rate less than a normal frame rate, such as a slower camera speed, a smaller number of images to be stored, a smaller number of images captured, a lower resolution, or the like. In an example, the image capture device may receive the indication from the facial recognition module and the image capture device may increase or decrease a frame rate using the indication.

FIG. 1F is a schematic diagram illustrating a system for displaying an avatar animation, including displaying an animation using a downloaded avatar.

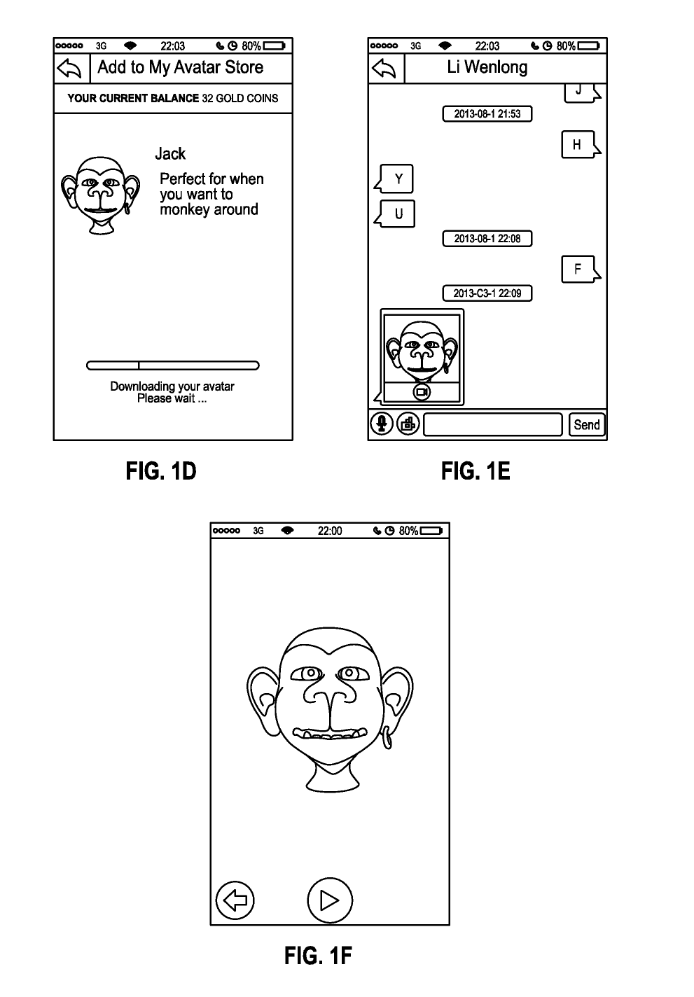

FIG. 2 is a flow chart illustrating a method 200 for playing an animation with a selected avatar, according to an embodiment. At block 202, the method 200 includes a receiving an animation of an avatar. At block 204, the method 200 includes extracting an avatar identifier, such as from an avatar sequencing data structure, and determining if the avatar exists locally. When it is determined that the avatar exists locally, the local avatar may be selected without downloading a new avatar (block 206). When it is determined that the avatar does not exist locally, the avatar may be downloaded (block 208). In an example, the downloaded avatar may be selected. In another example, a different avatar that is stored locally may be selected. At block 210, after an avatar is selected, the method 200 may include playing the animation with the selected avatar.

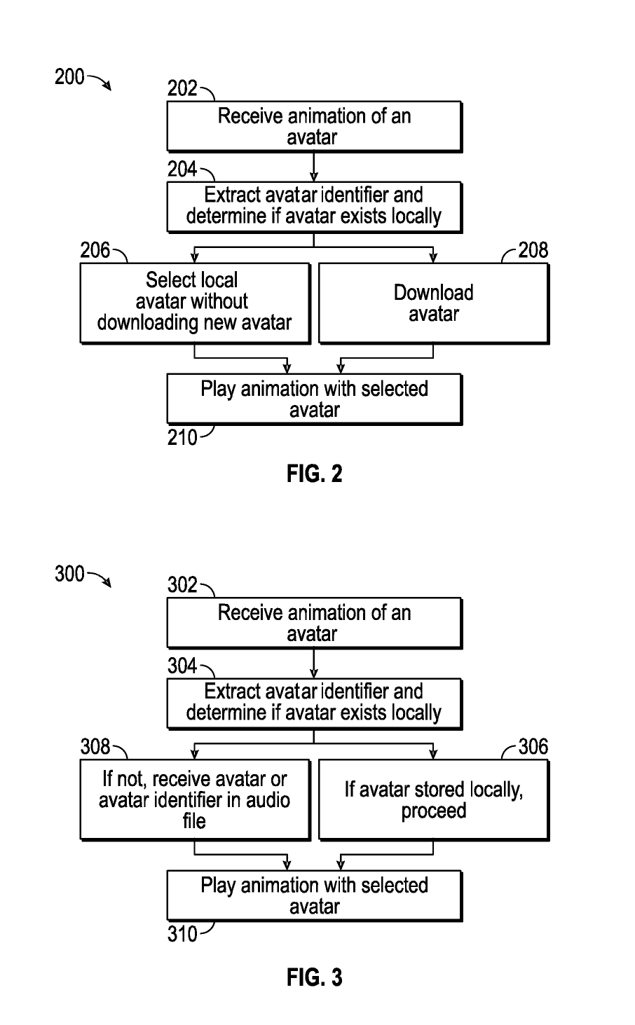

FIG. 3 is a flow chart illustrating a method 300 for playing an animation using an audio file, according to an embodiment. At block 302, the method 300 includes receiving an animation of an avatar. At block 304, the method 300 extracting an avatar identifier, such as from an avatar sequencing data structure, and determining if the avatar exists locally. When it is determined that the avatar exists locally, the method 300 includes selecting the local avatar (block 306). When it is determined that the avatar does not exist locally, the method 300 may include determining the avatar from an avatar identifier, such as from an avatar sequencing data structure, in an audio file (block 308). At block 310, after an avatar is selected, the method 300 includes playing the animation with the selected avatar.

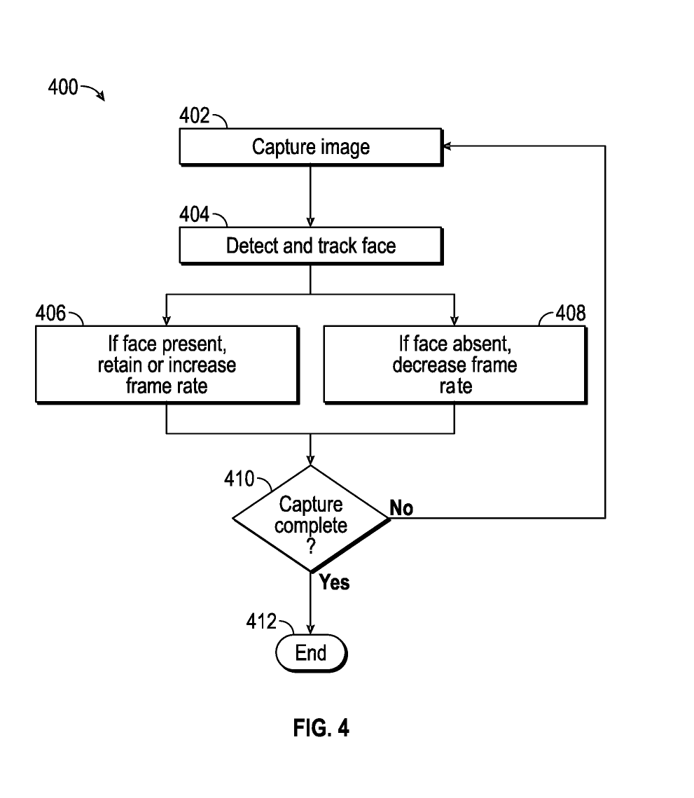

FIG. 4 is a flow chart illustrating a method 400 for adjusting a frame rate of an image capture device, according to an embodiment. The method 400 includes using an image capture device or image capture module to capture an image (block 402). In an example, the image capture device may be a camera. The method 400 may also include computing facial motion data for each of the images in the series of images. At block 404, the method 400 includes detecting a face, such as by determining if certain features are present. The method 400 may also track a face, such as by capturing a series of images and determining if certain features are in different places in consecutive images. In an example, if a face is present (e.g., detected), the method 400 may include operating at a normal frame rate (block 406). In an example, capturing a series of images at a normal frame rate may include capturing a series of images at thirty frames per second. In an example, the method may include detecting a face using an image quickly, such as in five to ten milliseconds or the like, if the image resolution is a resolution of a mobile phone, such as substantially 192 by 144 pixels. The method 400 may use significant system resources to detect the face and may not use significant system resources to capture images with no face detected.

In another example, if a face is absent, or not present, the image capture device or image capture module may operate at a reduced frame rate (block 408). In another example, a frame rate for the image capture device may be dynamically changed, such as by changing a camera sampling rate. A face may be absent from an image or a series of images, and if a threshold number of frames or duration is reached, the frame rate may be changed to five frames per second. The method 400 may include determining that the face is absent from an image or a series of images for a duration, such as thirty seconds, and the facial recognition module may send an indication to the image capture device to alter the frame rate. In another example, if the image capture device is operating at a reduced frame rate, and a face is detected as present in an image or a series of images, the method 400 may include sending an indication to the image capture device to change the frame rate to a normal frame rate.

At block 410, an indication may be received indicating whether the image capture device or image capture module has completed capturing images. In an example, a user may indicate that the image capture device has completed capturing images. For example, a user may hold down a button indicating that the image capture device should start capturing images and then the user may release the button indicating that the image capture device should stop capturing images. In another example, the image capture device may capture a series of images until a specified number of images or a specified duration is reached (e.g., capture images until 100 images are captured, one minute has elapsed, a memory is filled, or the like). If the image capture device has completed capturing images, the method 400 may end. If the image capture device has not completed capturing images, the method 400 may capture another image (block 402) and repeat.

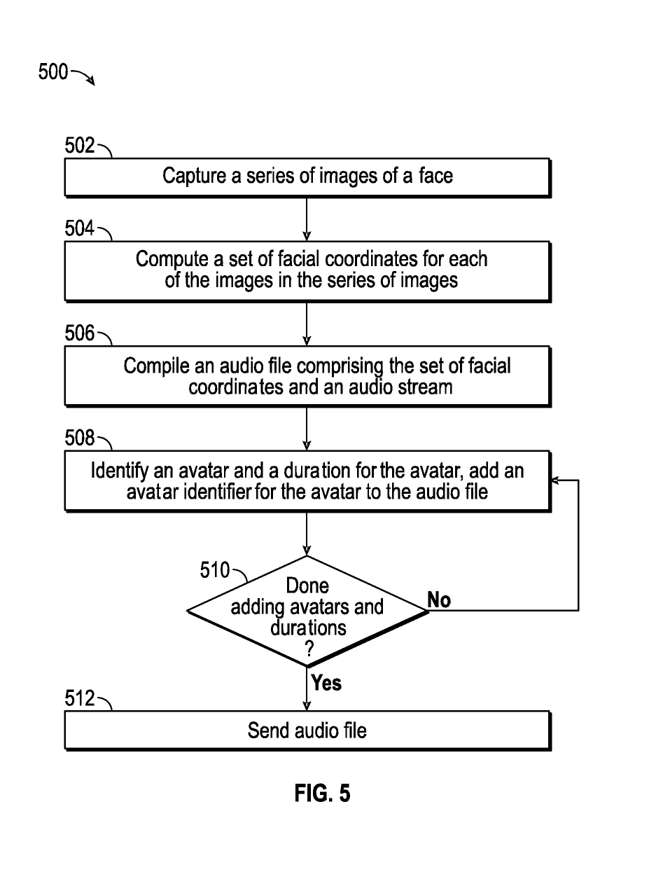

FIG. 5 is a flow chart illustrating a method 500 for sending an avatar in an audio file, according to an embodiment. The method 500 includes an image capture device or image capture module to capture a series of images of a face (block 502). In an example, the image capture device may be a camera. The method 500 also includes computing facial motion data, such as a set of facial coordinates, for each of the images in the series of images (block 504). At block 506, the method 500 includes compiling an audio file comprising the facial motion data, such as a set of facial coordinates, and an audio stream. At block 508, the method 500 includes identifying an avatar and a duration for the avatar and adding an avatar identifier corresponding to the avatar to the audio file.

In an example, an audio file may have a proprietary format. An avatar sequencing data structure may be added to an audio file with a proprietary format, such as by adding the avatar sequencing data structure as metadata in the audio file. For example, the avatar sequencing data structure may be added as a Universal Resource Locator (URL) for a proprietary avatar communication data structure. The URL may include information for extracting the avatar sequencing data structure or other attributes about an avatar, such as a duration. The audio file may include the avatar sequencing data structure or the avatar in metadata. If the audio file includes a URL including information for extracting the avatar, the audio file may be smaller (e.g., take up less memory) than if the avatar is included directly in the metadata. In an example, the proprietary format audio file may include an audio steam in a format such as MPEG4 and metadata.

In an example, an audio file may have a commercial format such as an Apple Core Audio Format. For example, data may be stored in reserved free chunk space in a Core Audio Format file without affecting audio playback. A Core Audio Format audio file may include an avatar, an avatar sequencing data structure, or other attributes about an avatar, such as a duration. The Core Audio Format includes free chunk header fields where an avatar and information about an avatar may be stored, such as mChunkType and mChunkSize.

In an example, the method 500 may also include adding the duration to the audio file. In another example, the method 500 may include adding an avatar sequencing data structure to the audio file. The avatar sequencing data structure may include an avatar identifier and a duration. More than one avatar identifier and duration or more than one avatar sequencing data structure may be added to the audio file (block 510 repeating block 508).

In an example, a user may record a message, such as a series of images and an audio recording. The user may choose an avatar or avatar identifier to send to a remote device, and the avatar may be used to animate the series of images and played with the audio recording. In an example, more than one avatar may be chosen for a specified message. A duration for each avatar chosen may also be chosen. The duration may be specified using timestamps, a length of time, a number of frames, or the like. The remote device may use one or more of the chosen avatars to animate the message or may use none of the avatars. In an example, the remote device may use an avatar selected at the remote device and an avatar identified in the audio file. For example, the remote device may animate the message using Avatars selected at the remote device, avatars identified in the audio file, or any combination of either of these types of avatars.

After the audio file is compiled with a specified number of avatar identifiers and durations (or avatar sequencing data structures), the method 500 may include sending the audio file (block 512).

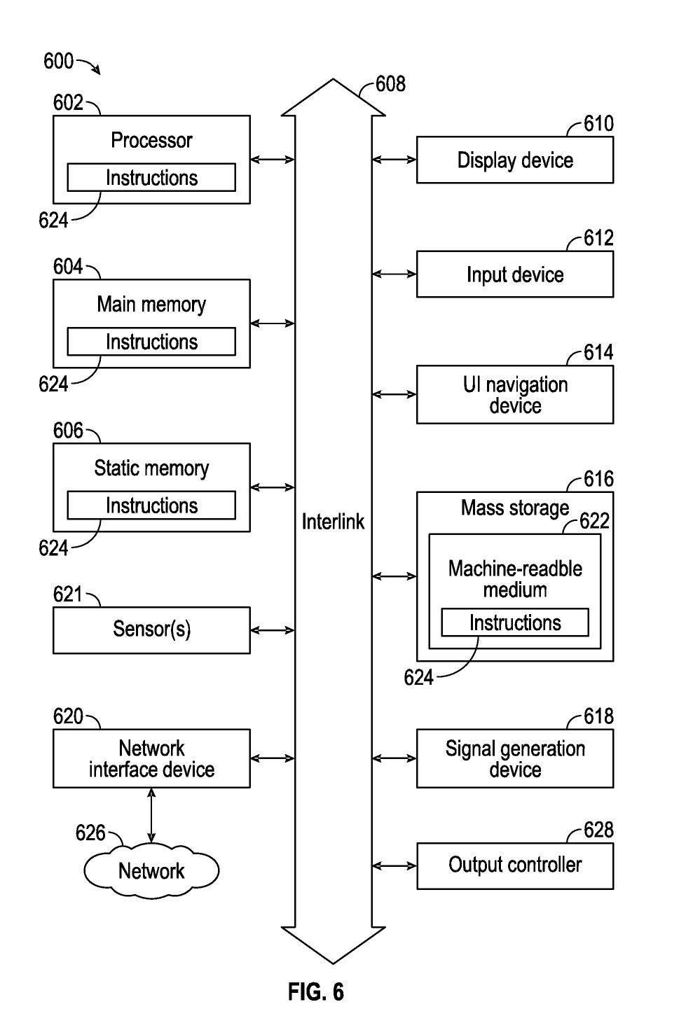

FIG. 6 is a block diagram of a machine 600 upon which one or more embodiments may be implemented. In alternative embodiments, the machine 600 can operate as a standalone device or can be connected (e.g., networked) to other machines. In a networked deployment, the machine 600 can operate in the capacity of a server machine, a client machine, or both in server-client network environments. In an example, the machine 600 can act as a peer machine in peer-to-peer (P2P) (or other distributed) network environment. The machine 600 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, can include, or can operate on, logic or a number of components, modules, or mechanisms. Modules are tangible entities (e.g., hardware) capable of performing specified operations when operating. A module includes hardware. In an example, the hardware can be specifically configured to carry out a specific operation (e.g., hardwired). In an example, the hardware can include configurable execution units (e.g., transistors, circuits, etc.) and a computer readable medium containing instructions, where the instructions configure the execution units to carry out a specific operation when in operation. The configuring can occur under the direction of the executions units or a loading mechanism. Accordingly, the execution units are communicatively coupled to the computer readable medium when the device is operating. In this example, the execution units can be a member of more than one module. For example, under operation, the execution units can be configured by a first set of instructions to implement a first module at one point in time and reconfigured by a second set of instructions to implement a second module.

Machine (e.g., a computer system) 600 can include a hardware processor 602 (e.g., a central processing unit (CPU), a graphics processing unit (GPU), a hardware processor core, or any combination thereof), a main memory 604 and a static memory 606, some or all of which can communicate with each other via an interlink (e.g., bus) 608. The machine 600 can further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 can be a touch screen display. The machine 600 can additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 can include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 can include a machine readable medium 622 that is non-transitory on which is stored one or more sets of data structures or instructions 624 (e.g., software) embodying or utilized by any one or more of the techniques or functions described herein. The instructions 624 can also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 can constitute machine readable media.

While the machine readable medium 622 is illustrated as a single medium, the term “machine readable medium” can include a single medium or multiple media (e.g., a centralized or distributed database, or associated caches and servers) configured to store the one or more instructions 624.

The term “machine readable medium” can include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples can include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 can further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 can include one or more physical jacks (e.g., Ethernet, coaxial, or phone jacks) or one or more antennas to connect to the communications network 626. In an example, the network interface device 620 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communication signals or other intangible medium to facilitate communication of such software.

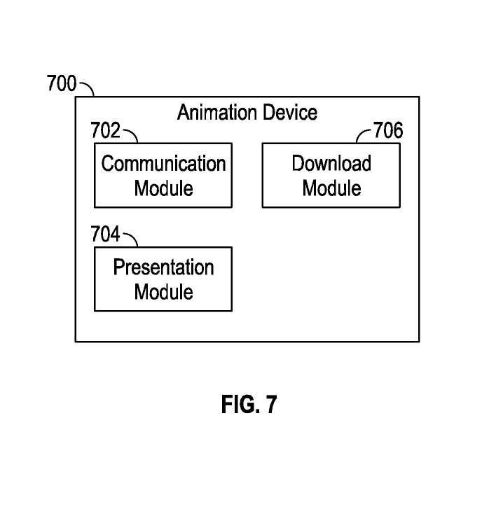

FIG. 7 is a block diagram illustrating an animation device for displaying an avatar animation, according to an embodiment. In an example, an animation device 700 may include a communication module 702 to receive an animation of an avatar and a presentation module 704 to extract an avatar identifier, such as from an avatar sequencing data structure, and determine if the avatar exists locally. When the presentation module 704 determines that the avatar exists locally, the presentation module 704 selects the local avatar without downloading a new avatar. When the presentation module 704 determines that the avatar does not exist locally, a download module 706 may download the avatar. In an example, the presentation module 704 may select the downloaded avatar. In another example, the presentation module 704 may select a different avatar that is stored locally. After an avatar is selected, the presentation module 704 plays the animation with the selected avatar.

In an example, a communication module 702 may receive an animation of an avatar. A presentation module 704 may extract an avatar identifier, such as from an avatar sequencing data structure, and determine if the avatar exists locally. When the presentation module 704 determines that the avatar exists locally, the presentation module 704 selects the local avatar. When the presentation module 704 determines that the avatar does not exist locally, the presentation module 704 may determine the avatar from an avatar identifier, such as from an avatar sequencing data structure, in an audio file. After an avatar is selected, the presentation module 704 plays the animation with the selected avatar.

An image capture device may use an image capture module (not shown) to capture an image or series of images. In an example, the image capture device may be a camera or the image capture module may include a camera. A facial recognition module (not shown) may compute facial motion data, such as a set of facial coordinates, for each of the images in the series of images. The facial recognition module may detect a face, such as by determining if certain features are present. The facial recognition module may also track a face, such as by capturing a series of images and determining if certain features are in different places in consecutive images. In an example, if a face is present (e.g., detected), the image capture device may operate at a normal frame rate. In an example, a facial recognition module may detect a face using an image in five milliseconds, if the image resolution is 192 by 144 pixels. The facial recognition module may use significant system resources to detect the face.

In another example, if the facial recognition module determines or fails to detect that a face is absent, or not present, the image capture device may operate at a reduced frame rate. The facial recognition module may determine that the face is absent from an image or a series of images for a duration, and the facial recognition module may send an indication to the image capture device to alter the frame rate. In another example, if the image capture device is operating at a reduced frame rate, and the facial recognition module detects that a face is present in an image or a series of images, the facial recognition module may send an indication to the image capture device to change the frame rate to a normal frame rate.

### ADDITIONAL NOTES & EXAMPLES

Example 1 includes the subject matter embodied by an animation device comprising: a communication module to receive, from an image capture device, an audio file comprising: facial motion data, the facial motion data derived from a series of facial images captured at the image capture device, an avatar sequencing data structure from the image capture device, the avatar sequencing data structure comprising an avatar identifier and a duration, and an audio stream, and a presentation module to present an animation of an avatar using the facial motion data and the audio stream.

In Example 2, the subject matter of Example 1 may optionally include wherein to present the animation of the avatar, the presentation module is to animate the avatar using the avatar identifier.

In Example 3, the subject matter of one or any combination of Examples 1-2 may optionally include wherein to present the animation of the avatar, the presentation module is to animate the avatar for a period of time lasting for the duration.

In Example 4, the subject matter of one or any combination of Examples 1-3 may optionally include wherein to present the animation of the avatar, the presentation module is to animate the avatar, not using the avatar identifier, for a period of time lasting for the duration.

In Example 5, the subject matter of one or any combination of Examples 1-4 may optionally include wherein to present the animation of the avatar, the presentation module is to animate a locally-selected avatar that is selected locally at the second device.

In Example 6, the subject matter of one or any combination of Examples 1-5 may optionally include wherein to present the animation of the avatar, the presentation module is to select the avatar from local memory of the animation device.

In Example 7, the subject matter of one or any combination of Examples 1-6 may optionally include further comprising a download module to download the avatar from a server at the second device.

In Example 8, the subject matter of one or any combination of Examples 1-7 may optionally include wherein the communication module receives either a proprietary avatar communication data structure or a Core Audio Format (CAF) communication data structure, and wherein when the communication module receives the proprietary avatar communication data structure, the communication module extracts the avatar sequencing data structure using a Universal Resource Locator (URL) stored in metadata of the proprietary avatar communication data structure, and wherein when the communication module receives the CAF communication data structure, the communication module extracts the avatar sequencing data structure stored in reserved free chunk space in the CAF communication data structure.

In Example 9, the subject matter of one or any combination of Examples 1-8 may optionally include wherein the audio file comprises a second avatar sequencing data structure, the second avatar sequencing data structure comprising a second avatar identifier and a second duration.

In Example 10, the subject matter of one or any combination of Examples 1-9 may optionally include wherein to present the animation, the presentation module is to present a first animation of the avatar corresponding to the avatar identifier for a period of time lasting the duration and a second animation of a second avatar corresponding to the second avatar identifier a period of time lasting the second duration.

In Example 11, the subject matter of one or any combination of Examples 1-10 may optionally include wherein to present the animation of the avatar, the presentation module is to use two avatars.

In Example 12, the subject matter of one or any combination of Examples 1-11 may optionally include wherein the two avatars are selected locally at the image capture device.

In Example 13, the subject matter of one or any combination of Examples 1-12 may optionally include wherein the two avatars are selected locally at the animation device.

In Example 14, the subject matter of one or any combination of Examples 1-13 may optionally include wherein one of the two avatars is identified by the avatar identifier.

In Example 15, the subject matter of one or any combination of Examples 1-14 may optionally include wherein the audio file further comprises a specified number of avatar sequencing data structures.

In Example 16, the subject matter of one or any combination of Examples 1-15 may optionally include wherein to present the animation of the avatar, the presentation module is to use a different number of avatars than the specified number of avatar sequencing data structures.

In Example 17, the subject matter of one or any combination of

Examples 1-16 may optionally include wherein to present the animation of the avatar, the presentation module is to animate the avatar, using a locally-selected avatar that is selected locally at the animation device, for a period of time lasting for a sum of all durations in the avatar sequencing data structures.

Example 18 includes the subject matter embodied by an image capture device comprising:an image capture module to capture a series of images of a face, a facial recognition module to compute facial motion data for each of the images in the series of images, and a communication module to send to an animation device, an audio file comprising: the facial motion data, an avatar sequencing data structure, the avatar sequencing data structure comprising an avatar identifier and a duration, and an audio stream, and wherein the animation device is configured to use the facial motion data and the audio stream to animate an avatar on the animation device.

In Example 19, the subject matter of Example 18 may optionally include wherein to animate the avatar, the animation device is to animate the avatar using the avatar identifier.

In Example 20, the subject matter of one or any combination of Examples 18-19 may optionally include wherein to animate the avatar, the animation device is to animate the avatar for a period of time lasting for the duration.

In Example 21, the subject matter of one or any combination of Examples 18-20 may optionally include wherein to animate the avatar, the animation device is to animate the avatar, not using the avatar identifier, for a period of time lasting for the duration.

In Example 22, the subject matter of one or any combination of Examples 18-21 may optionally include wherein to animate the avatar, the animation device is to animate a locally-selected avatar that is selected locally at the animation device.

In Example 23, the subject matter of one or any combination of Examples 18-22 may optionally include wherein to animate the avatar, the animation device is to select the avatar from local memory of the animation device.

In Example 24, the subject matter of one or any combination of Examples 18-23 may optionally include wherein the animation device is further configured to download the avatar from a server.

In Example 25, the subject matter of one or any combination of Examples 18-24 may optionally include wherein the communication module sends either a proprietary avatar communication data structure or a Core Audio Format (CAF) communication data structure, and wherein when the communication module sends the proprietary avatar communication data structure, the communication module stores the avatar sequencing data structure,using a Universal Resource Locator (URL), in metadata of the proprietary avatar communication data structure, and wherein when the communication module sends the CAF communication data structure, the communication module stores the avatar sequencing data structure in reserved free chunk space in the CAF communication data structure.

In Example 26, the subject matter of one or any combination of Examples 18-25 may optionally include wherein the audio file comprises a second avatar sequencing data structure, the second avatar sequencing data structure comprising a second avatar identifier and a second duration.

In Example 27, the subject matter of one or any combination of Examples 18-26 may optionally include wherein to animate the avatar, the animation device is to animate a first animation of the avatar corresponding to the avatar identifier for a period of time lasting the duration and a second animation of a second avatar corresponding to the second avatar identifier a period of time lasting the second duration.

In Example 28, the subject matter of one or any combination of Examples 18-27 may optionally include wherein the animation device is further configured to use two avatars.

In Example 29, the subject matter of one or any combination of Examples 18-28 may optionally include wherein the animation device is further configured to select the two avatars locally at the image capture device.

In Example 30, the subject matter of one or any combination of Examples 18-29 may optionally include wherein the animation device is further configured to select the two avatars locally at the animation device.

In Example 31, the subject matter of one or any combination of Examples 18-30 may optionally include wherein one of the avatars is identified by the first avatar identifier.

In Example 32, the subject matter of one or any combination of Examples 18-31 may optionally include wherein the audio file further comprises a specified number of avatar sequencing data structures.

In Example 33, the subject matter of one or any combination of Examples 18-32 may optionally include wherein to animate the avatar, the animation device is to use a different number of avatars than the specified number of avatar sequencing data structures.

In Example 34, the subject matter of one or any combination of Examples 18-33 may optionally include wherein to animate the avatar, the animation device is to animate the avatar, using a locally-selected avatar that is selected locally at the animation device, for a period of time lasting for a sum of all durations in the avatar sequencing data structures.

In Example 35, the subject matter of one or any combination of Examples 18-34 may optionally include wherein the facial recognition module is further configured to detect if the face is present in the series of images captured by the image capture device.

In Example 36, the subject matter of one or any combination of Examples 18-35 may optionally include wherein the image capture module operates at a normal frame rate if the facial recognition module detects that the face is present in the series of images.

In Example 37, the subject matter of one or any combination of Examples 18-36 may optionally include wherein the image capture module operates at a reduced frame rate if the facial recognition module detects that the face is absent in the series of images.

Example 38 includes the subject matter embodied by an avatar presentation method comprising: receiving, at a second device from a first device, an audio file comprising: facial motion data, the facial motion data derived from a series of facial images captured at the first device, an avatar sequencing data structure from the first device, the avatar sequencing data structure comprising an avatar identifier and a duration, and an audio stream, and presenting an animation of an avatar, at the second device, using the facial motion data and the audio stream.

In Example 39, the subject matter of Example 18 may optionally include further comprising, selecting the avatar using the avatar identifier.

In Example 40, the subject matter of one or any combination of Examples 38-39 may optionally include further comprising, presenting the animation of the avatar for a period of time lasting for the duration.

In Example 41, the subject matter of one or any combination of Examples 38-40 may optionally include further comprising, selecting the avatar by not using the avatar identifier.

In Example 42, the subject matter of one or any combination of Examples 38-41 may optionally include further comprising, selecting the avatar locally at the second device.

In Example 43, the subject matter of one or any combination of Examples 38-42 may optionally include wherein selecting the avatar includes selecting the avatar from local memory of the second device.

In Example 44, the subject matter of one or any combination of Examples 38-43 may optionally include further comprising, downloading the avatar from a server at the second device.

In Example 45, the subject matter of one or any combination of Examples 38-44 may optionally include wherein receiving includes receiving either a proprietary avatar communication data structure or a Core Audio Format (CAF) communication data structure, and wherein after receiving the proprietary avatar communication data structure, extracting the avatar sequencing data structure using a Universal Resource Locator (URL) stored in metadata of the proprietary avatar communication data structure, and wherein after receiving the CAF communication data structure, extracting the avatar sequencing data structure stored in reserved free chunk space in the CAF communication data structure.

In Example 46, the subject matter of one or any combination of Examples 38-45 may optionally include wherein the audio file comprises a second avatar sequencing data structure, the second avatar sequencing data structure comprising a second avatar identifier and a second duration.

In Example 47, the subject matter of one or any combination of Examples 38-46 may optionally include wherein presenting the animation includes presenting a first animation of the avatar corresponding to the avatar identifier for a period of time lasting the duration and a second animation of a second avatar corresponding to the second avatar identifier a period of time lasting the second duration.

In Example 48, the subject matter of one or any combination of Examples 38-47 may optionally include wherein the audio file comprises a second avatar identifier.

In Example 49, the subject matter of one or any combination of Examples 38-48 may optionally include wherein presenting the animation of the avatar includes using two avatars.

In Example 50, the subject matter of one or any combination of Examples 38-49 may optionally include further comprising, selecting the two avatars locally at the first device.

In Example 51, the subject matter of one or any combination of Examples 38-50 may optionally include further comprising, selecting the two avatars locally at the second device.

In Example 52, the subject matter of one or any combination of Examples 38-51 may optionally include wherein one of the two avatars is identified by the first avatar identifier.

In Example 53, the subject matter of one or any combination of Examples 38-52 may optionally include wherein the audio file further comprises a specified number of avatar sequencing data structures.

In Example 54, the subject matter of one or any combination of Examples 38-53 may optionally include wherein presenting the animation of the avatar includes using a different number of avatars than the specified number of avatar sequencing data structures.

In Example 55, the subject matter of one or any combination of Examples 38-54 may optionally include wherein presenting the animation of the avatar includes presenting the animation, using a locally-selected avatar that is selected locally at the second device, for a period of time lasting for a sum of all durations in the avatar sequencing data structures.

In Example 56, the subject matter of one or any combination of Examples 38-55 may optionally include a machine-readable medium including instructions for receiving information, which when executed by a machine, cause the machine to perform any of the methods of Examples 38-55.

Example 57 includes the subject matter embodied by a machine-readable medium including instructions for receiving information, which when executed by a machine, cause the machine to:receive, at a second device from a first device, an audio file comprising: facial motion data, the facial motion data derived from a series of facial images captured at the first device, an avatar sequencing data structure from the first device, the avatar sequencing data structure comprising an avatar identifier and a duration, and an audio stream; and present an animation, at the second device, of an avatar using the facial motion data and the audio stream.

In Example 58, the subject matter of Example 18 may optionally include further comprising, selecting the avatar using the avatar identifier.

In Example 59, the subject matter of one or any combination of Examples 57-58 may optionally include further comprising instructions for receiving information, which when executed by a machine, cause the machine to: present the animation of the avatar for a period of time lasting for the duration.

In Example 60, the subject matter of one or any combination of Examples 57-59 may optionally include further comprising instructions for receiving information, which when executed by a machine, cause the machine to: select the avatar by not using the avatar identifier.

In Example 61, the subject matter of one or any combination of Examples 57-60 may optionally include further comprising instructions for receiving information, which when executed by a machine, cause the machine to: select the avatar locally at the second device.

In Example 62, the subject matter of one or any combination of Examples 57-61 may optionally include wherein to select the avatar includes to select the avatar from local memory of the second device.

In Example 63, the subject matter of one or any combination of Examples 57-62 may optionally include further comprising instructions for receiving information, which when executed by a machine, cause the machine to: download the avatar from a server at the second device.

In Example 64, the subject matter of one or any combination of Examples 57-63 may optionally include wherein to receive includes to receive either a proprietary avatar communication data structure or a Core Audio Format (CAF) communication data structure, and wherein after receiving the proprietary avatar communication data structure, to extract the avatar sequencing data structure using a Universal Resource Locator (URL) stored in metadata of the proprietary avatar communication data structure, and wherein after receiving the CAF communication data structure, to extract the avatar sequencing data structure stored in reserved free chunk space in the CAF communication data structure.

In Example 65, the subject matter of one or any combination of Examples 57-64 may optionally include wherein the audio file comprises a second avatar sequencing data structure, the second avatar sequencing data structure comprising a second avatar identifier and a second duration.

In Example 66, the subject matter of one or any combination of Examples 57-65 may optionally include wherein to present the animation includes to present a first animation of the avatar corresponding to the avatar identifier for a period of time lasting the duration and a second animation of a second avatar corresponding to the second avatar identifier a period of time lasting the second duration.

In Example 67, the subject matter of one or any combination of Examples 57-66 may optionally include wherein the audio file comprises a second avatar identifier.

In Example 68, the subject matter of one or any combination of Examples 57-67 may optionally include wherein to present the animation of the avatar includes to present the animation of the avatar using two avatars.

In Example 69, the subject matter of one or any combination of Examples 57-68 may optionally include further comprising instructions for receiving information, which when executed by a machine, cause the machine to: select the two avatars locally at the first device.

In Example 70, the subject matter of one or any combination of Examples 57-69 may optionally include further comprising instructions for receiving information, which when executed by a machine, cause the machine to: select the two avatars locally at the second device.

In Example 71, the subject matter of one or any combination of Examples 57-70 may optionally include wherein one of the two avatars is identified by the first avatar identifier.

In Example 72, the subject matter of one or any combination of Examples 57-71 may optionally include wherein the audio file further comprises a specified number of avatar sequencing data structures.

In Example 73, the subject matter of one or any combination of Examples 57-72 may optionally include wherein to present the animation of the avatar includes to present the animation of the avatar using a different number of avatars than the specified number of avatar sequencing data structures.

In Example 74, the subject matter of one or any combination of Examples 57-73 may optionally include wherein to present the animation of the avatar includes to present the animation of the avatar, using a locally-selected avatar that is selected locally at the second device, for a period of time lasting for a sum of all durations in the avatar sequencing data structures.

In Example 75, the subject matter of one or any combination of Examples 38-55 may optionally include an apparatus comprising means for performing any of the methods of Examples 38-55.

Example 76 includes the subject matter embodied by an apparatus comprising: means for receiving, at a second device from a first device, an audio file comprising: facial motion data, the facial motion data derived from a series of facial images captured at the first device, an avatar sequencing data structure from the first device, the avatar sequencing data structure comprising an avatar identifier and a duration, and an audio stream, and means for presenting an animation, at the second device, of an avatar using the facial motion data and the audio stream.

Example 77 includes the subject matter embodied by an audio file delivery method comprising: capturing a series of images of a face using an image capture device, computing facial motion data for each of the images in the series of images, and sending, to an animation device, an audio file comprising: the facial motion data, an avatar sequencing data structure, the avatar sequencing data structure comprising an avatar identifier and a duration, and an audio stream, detecting that the animation device is configured to use the facial motion data and the audio stream to animate an avatar on the animation device.

In Example 78, the subject matter of Example 77 may optionally include wherein the avatar is selected using the avatar identifier.

In Example 79, the subject matter of one or any combination of Examples 77-78 may optionally include further comprising, detecting that the animation device is configured to animate the avatar for a period of time lasting for the duration.

In Example 80, the subject matter of one or any combination of Examples 77-79 may optionally include wherein the avatar is not selected by the avatar identifier.

In Example 81, the subject matter of one or any combination of Examples 77-80 may optionally include further comprising, detecting that the animation device is configured to select the avatar.

In Example 82, the subject matter of one or any combination of Examples 77-81 may optionally include further comprising, detecting that the animation device is configured to select the avatar from local memory of the animation device.

In Example 83, the subject matter of one or any combination of Examples 77-82 may optionally include further comprising, detecting that the animation device is configured to download the avatar from a server.

In Example 84, the subject matter of one or any combination of Examples 77-83 may optionally include wherein sending includes sending either a proprietary avatar communication data structure or a Core Audio Format (CAF) communication data structure, and wherein before sending the proprietary avatar communication data structure, storing the avatar sequencing data structure,using a Universal Resource Locator (URL), in metadata of the proprietary avatar communication data structure, and wherein before sending the CAF communication data structure, storing the avatar sequencing data structure in reserved free chunk space in the CAF communication data structure.

In Example 85, the subject matter of one or any combination of Examples 77-84 may optionally include wherein the audio file comprises a second avatar sequencing data structure, the second avatar sequencing data structure comprising a second avatar identifier and a second duration.

In Example 86, the subject matter of one or any combination of Examples 77-85 may optionally include further comprising, detecting that to animate the avatar, the animation device is configured to animate a first animation of the avatar corresponding to the avatar identifier for a period of time lasting the duration and a second animation of a second avatar corresponding to the second avatar identifier a period of time lasting the second duration.

In Example 87, the subject matter of one or any combination of Examples 77-86 may optionally include further comprising, detecting that the animation device is configured to use two avatars.

In Example 88, the subject matter of one or any combination of Examples 77-87 may optionally include further comprising, detecting that the animation device is configured to select the two avatars locally at the image capture device.

In Example 89, the subject matter of one or any combination of Examples 77-88 may optionally include further comprising, detecting that the animation device is configured to select the two avatars locally at the animation device.

In Example 90, the subject matter of one or any combination of Examples 77-89 may optionally include wherein one of the avatars is identified by the first avatar identifier.

In Example 91, the subject matter of one or any combination of Examples 77-90 may optionally include wherein the audio file further comprises a specified number of avatar sequencing data structures.

In Example 92, the subject matter of one or any combination of Examples 77-91 may optionally include further comprising, detecting that the animation device is configured to use a different number of avatars than the specified number of avatar sequencing data structures.

In Example 93, the subject matter of one or any combination of Examples 77-92 may optionally include further comprising, detecting that the animation device is configured to animate the avatar, using a locally-selected avatar that is selected locally at the animation device, for a period of time lasting for a sum of all durations in the avatar sequencing data structures.

In Example 94, the subject matter of one or any combination of Examples 77-93 may optionally include further comprising, detecting if the face is present in the series of images captured by the image capture device.

In Example 95, the subject matter of one or any combination of Examples 77-94 may optionally include wherein capturing the series of images includes capturing the series of images at a normal frame rate if the face is present in the series of images.

In Example 96, the subject matter of one or any combination of Examples 77-95 may optionally include wherein capturing the series of images includes capturing the series of images at a reduced frame rate if the face is absent in the series of images.

In Example 97, the subject matter of one or any combination of Examples 77-96 may optionally include a machine-readable medium including instructions for receiving information, which when executed by a machine, cause the machine to perform any of the methods of claims 77-96.

Example 98 includes the subject matter embodied by a machine-readable medium including instructions for receiving information, which when executed by a machine, cause the machine to:capture a series of images of a face using an image capture device, compute facial motion data for each of the images in the series of images, and send, to an animation device, an audio file comprising: the facial motion data, an avatar sequencing data structure, the avatar sequencing data structure comprising an avatar identifier and a duration, and an audio stream, wherein the animation device is configured to use the facial motion data and the audio stream to animate an avatar on the animation device.

In Example 99, the subject matter of one or any combination of Examples 77-96 may optionally include an apparatus comprising means for performing any of the methods of claims 77-96.

Example 100 includes the subject matter embodied by an apparatus comprising: means for capturing a series of images of a face using an image capture device, means for computing facial motion data for each of the images in the series of images, and means for sending, to an animation device, an audio file comprising: the facial motion data, an avatar sequencing data structure, the avatar sequencing data structure comprising an avatar identifier and a duration, and an audio stream, wherein the animation device is configured to use the facial motion data and the audio stream to animate an avatar on the animation device.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.”Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples(or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.”In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1.-25. (canceled)

26. An animation device comprising:
a communication module to receive, from an image capture device, an audio file comprising:
facial motion data, the facial motion data derived from a series of facial images captured at the image capture device;
an avatar sequencing data structure from the image capture device, the avatar sequencing data structure comprising an avatar identifier and a duration; and
an audio stream; and
a presentation module to present an animation of an avatar using the facial motion data and the audio stream.

27. The animation device of claim 26, wherein to present the animation of the avatar, the presentation module is to animate the avatar using the avatar identifier.

28. The animation device of claim 26, wherein to present the animation of the avatar, the presentation module is to animate the avatar for a period of time lasting for the duration.

29. The animation device of claim 26, wherein to present the animation of the avatar, the presentation module is to animate the avatar, not using the avatar identifier, for a period of time lasting for the duration.

30. The animation device of claim 26, wherein to present the animation of the avatar, the presentation module is to animate a locally-selected avatar that is selected locally at the second device.

31. The animation device of claim 30, wherein to present the animation of the avatar, the presentation module is to select the avatar from local memory of the animation device.

32. The animation device of claim 26, further comprising a download module to download the avatar from a server at the second device.

33. The animation device of claim 26, wherein the communication module receives either a proprietary avatar communication data structure or a Core Audio Format (CAF) communication data structure; and
wherein when the communication module receives the proprietary avatar communication data structure, the communication module extracts the avatar sequencing data structure using a Universal Resource Locator (URL) stored in metadata of the proprietary avatar communication data structure; and
wherein when the communication module receives the CAF communication data structure, the communication module extracts the avatar sequencing data structure stored in reserved free chunk space in the CAF communication data structure.

34. The animation device of claim 26, wherein the audio file comprises a second avatar sequencing data structure, the second avatar sequencing data structure comprising a second avatar identifier and a second duration.

35. The animation device of claim 34, wherein to present the animation, the presentation module is to present a first animation of the avatar corresponding to the avatar identifier for a period of time lasting the duration and a second animation of a second avatar corresponding to the second avatar identifier a period of time lasting the second duration.

36. The animation device of claim 26, wherein to present the animation of the avatar, the presentation module is to use two avatars.

37. The animation device of claim 36, wherein the two avatars are selected locally at the image capture device.

38. The animation device of claim 36, wherein the two avatars are selected locally at the animation device.

39. The animation device of claim 36, wherein one of the two avatars is identified by the avatar identifier.

40. The animation device of claim 26, wherein the audio file further comprises a specified number of avatar sequencing data structures.

41. The animation device of claim 40, wherein to present the animation of the avatar, the presentation module is to use a different number of avatars than the specified number of avatar sequencing data structures.

42. The animation device of claim 41, wherein to present the animation of the avatar, the presentation module is to animate the avatar, using a locally-selected avatar that is selected locally at the animation device, for a period of time lasting for a sum of all durations in the avatar sequencing data structures.

43. An image capture device comprising:
an image capture module to capture a series of images of a face;
a facial recognition module to compute facial motion data for each of the images in the series of images; and
a communication module to send to an animation device, an audio file comprising:
the facial motion data;
an avatar sequencing data structure, the avatar sequencing data structure comprising an avatar identifier and a duration; and
an audio stream; and
wherein the animation device is configured to use the facial motion data and the audio stream to animate an avatar on the animation device.

44. The image capture device of claim 43, wherein the facial recognition module is further configured to detect if the face is present in the series of images captured by the image capture device and wherein the image capture module operates at a normal frame rate if the facial recognition module detects that the face is present in the series of images and the image capture module operates at a reduced frame rate if the facial recognition module detects that the face is absent in the series of images.

45. An avatar presentation method comprising:
receiving, at a second device from a first device, an audio file comprising:
facial motion data, the motion coordinate data derived from a series of facial images captured at the first device;
an avatar sequencing data structure from the first device, the avatar sequencing data structure comprising an avatar identifier and a duration; and
an audio stream; and
presenting an animation of an avatar, at the second device, using the facial motion data and the audio stream.

46. A machine-readable medium including instructions for receiving information, which when executed by a machine, cause the machine to:
receive, at a second device from a first device, an audio file comprising:
facial motion data, the facial motion data derived from a series of facial images captured at the first device;
an avatar sequencing data structure from the first device, the avatar sequencing data structure comprising an avatar identifier and a duration; and
an audio stream; and
present an animation, at the second device, of an avatar using the facial motion data and the audio stream.

47. The machine-readable medium of claim 46, further comprising, selecting the avatar using the avatar identifier.

48. The machine-readable medium of claim 46, further comprising instructions for receiving information, which when executed by a machine, cause the machine to: download the avatar from a server at the second device.

49. The machine-readable medium of claim 46, wherein to receive includes to receive either a proprietary avatar communication data structure or a Core Audio Format (CAF) communication data structure; and
wherein after receiving the proprietary avatar communication data structure, to extract the avatar sequencing data structure using a Universal Resource Locator (URL) stored in metadata of the proprietary avatar communication data structure; and
wherein after receiving the CAF communication data structure, to extract the avatar sequencing data structure stored in reserved free chunk space in the CAF communication data structure.

50. The machine-readable medium of claim 46, wherein the audio file comprises a second avatar identifier and wherein to present the animation of the avatar includes to present the animation of the avatar using two avatars.
